(19) United States
(12) Patent Application Publication
(10) Pub. No.: US 2026/0329726 A1
(43) Pub. Date: Oct. 22, 2026

(54) DETECTING SOFTWARE REGRESSIONS USING CLUSTERING OF SEMANTIC ERROR LOG VECTORS

(71) Applicant: Microsoft Technology Licensing, LLC, Redmond, WA (US)

(72) Inventor: Santhana Gopalan RAGHAVAN, Fremont, CA (US)

(21) Appl. No.: 19/183,747

(22) Filed: Apr. 18, 2025

(51) Int. Cl. G06F 11/362; G06F 11/34

(52) U.S. Cl. CPC G06F 11/3636; G06F 11/3452; G06F 11/3476

(57) ABSTRACT

A computerized method detects and mitigates regression errors in software services. Error log data associated with a current version of the service is obtained from a data store. The error log data is transformed into a first group of error log vectors using a model, wherein the first group of error log vectors represents semantic meaning of the error logs. A second group of error log vectors associated with a previous version of the service is obtained. Based on semantic similarity, the first group and the second group of error log vectors are clustered and, based on the clustering, a vector cluster that includes error log vectors from the first group and no error log vectors from the second group is identified as a regression vector cluster. Regression data associated with the regression vector cluster is generated and a regression mitigation action is performed using the generated regression data.

### BACKGROUND

Detecting regressions in software systems is a critical task during the development and release cycle of software services. Traditional regression detection methods rely on static schemas of stack traces and/or rule-based heuristics, which often result in high false positives due to schema variability (e.g., changes in line numbers, upstream functions, or minor variations in error messages lead to misclassification of known issues as new anomalies). Existing solutions fail to capture the semantic meaning of such stack traces or other log information, leading to inefficiencies in identifying true regression and prolonging the associated debugging process.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for detecting and mitigating regression errors in software services is described. Error log data associated with a current version of the service is obtained from a data store. The error log data is transformed into a first group of error log vectors using a model, wherein the first group of error log vectors represents semantic meaning of one or more error logs of the obtained error log data associated with the current version of the service. A second group of error log vectors associated with a previous version of the service is obtained. Based on semantic similarity, the first group of error log vectors and the second group of error log vectors are clustered and, based on the clustering, a vector cluster that includes error log vectors from the first group of error log vectors and no error log vectors from the second group of error log vectors is identified as a regression vector cluster. Regression data associated with the regression vector cluster is generated and a regression mitigation action is performed using the generated regression data.

### BRIEF DESCRIPTION OF THE DRAWINGS

The present description will be better understood from the following detailed description read considering the accompanying drawings, wherein:

FIG. 1 is a block diagram illustrating an example system configured for detecting regression anomalies in a new version of a service;

FIG. 2 is a diagram illustrating a 3-dimensional space in which clusters of vectors are placed;

FIG. 3 is a flowchart illustrating an example method for identifying and mitigating regression errors in a version of a software service;

FIG. 4 is a flowchart illustrating an example method for evaluating error vector clusters; and

FIG. 5 illustrates an example computing apparatus as a functional block diagram.

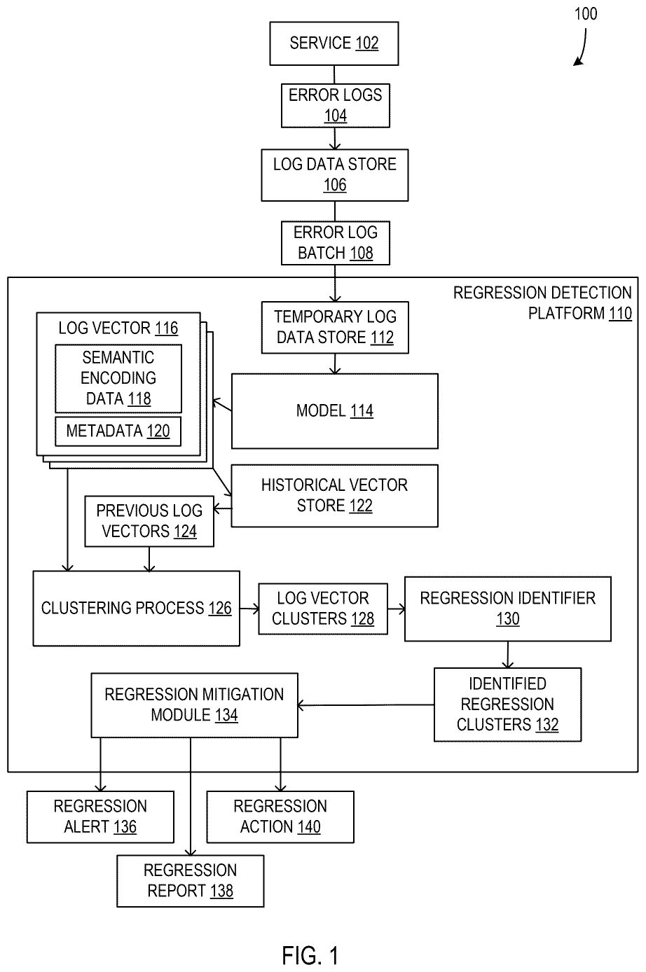

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide systems and methods for automatically detecting regression errors in software services and/or other applications using the error logs generated by that software. The error logs are transformed into error log vectors using a model (e.g., a large language model (LLM) or other model), wherein the error log vectors include data representing the semantic meaning of the information in the error logs. These error log vectors are then grouped into clusters using a clustering algorithm and those vector clusters are compared to similar vector clusters from a previous version of the software service. Because the error log vectors are clustered based on semantic similarity, clusters of the current version of the software that overlap clusters of the previous version of the software are likely to be associated with errors that have not been addressed, while cluster of the current version of software that do not overlap with any clusters of the previous version of the software are likely to be associated with novel regression errors. The data associated with those regression clusters is then used to perform one or more regression mitigation actions which enable the regression errors to be addressed and/or prevent the regression errors from negatively affecting the operation of the service.

The disclosure operates in an unconventional manner at least by automatically detecting and mitigating regression errors in software services using semantically encoded vectors and clustering algorithms. Error log information such as stack traces are converted into semantic encoding data and combined into clusters with similar vectors from previous versions of the service. Clusters that do not include vectors from the previous versions of the service represent regression errors introduced into the service in the most recent version. Examples of the disclosure are directed to a particular improvement in the regression detection and testing portion of the software development process. Specifically, the use of semantic encoding of error logs provides an automated, accurate method for identifying issues that have been newly introduced into a new version of a software service. This provides a specific improvement over prior systems, resulting in improved accuracy of regression detection and reduced false positives (e.g., based on schema variability in stack traces) compared to those prior systems. The described processes are integrated into a practical application of automatically detecting and mitigating regression errors in software services.

More specifically, aspects of the disclosure provide for regression detection by leveraging embedding models (e.g., OpenAI's text-embedding-ada-002) to transform stack traces into high-dimensional vector representations that capture their semantic meaning. These embeddings are then clustered using unsupervised learning techniques to group similar errors into semantic clusters. By comparing clusters across successive builds, the system identifies anomalies that represent novel regressions. Using models as a transformational filter reduces false positives by focusing on the semantics of stack traces rather than their syntactic structure. The described systems and methods improve accuracy by grouping errors based on their meaning, irrespective of superficial variations. Additionally, the systems and methods can scale efficiently with large volumes of data due to the use of semantic encoding vectors and clustering algorithms optimized for high-dimensional spaces.

Additionally, or alternatively, in some examples, the disclosure uses unsupervised clustering algorithms, such as Density-Based Spatial Clustering of Applications with Noise (DBSCAN) or k-means clustering, to group the error log vectors with clusters representing semantically similar errors. The clusters from one version or build of the service are compared with clusters from an earlier version or build of the service, and clusters of the more recent version that do not significantly overlap with clusters from the earlier version of the service are flagged as potential regressions. Alternatively, or additionally, the vectors from both versions are clustered together and clusters that include only vectors from the more recent version of the service are flagged as potential regressions.

Aspects of the disclosure include the identification of anomalies or potentially novel regressions as described herein and the provision of additional contextual information, such as sample file names, operation identifiers, line numbers, or the like for use in debugging the identified issues. Further, any detected regressions are stored in a data store for further processing, alerting, and/or reporting.

FIG. 1 is a block diagram illustrating an example system 100 configured for detecting regression anomalies in a new version of a service 102. In some examples, error logs 104 associated with the new version of the service 102 are analyzed by a regression detection platform 110 and the results are compared to analysis results from previous versions of the service 102. Newly introduced anomalies or regressions are detected based on this comparison and anomaly mitigation actions are taken in response to the detection of those newly introduced anomalies.

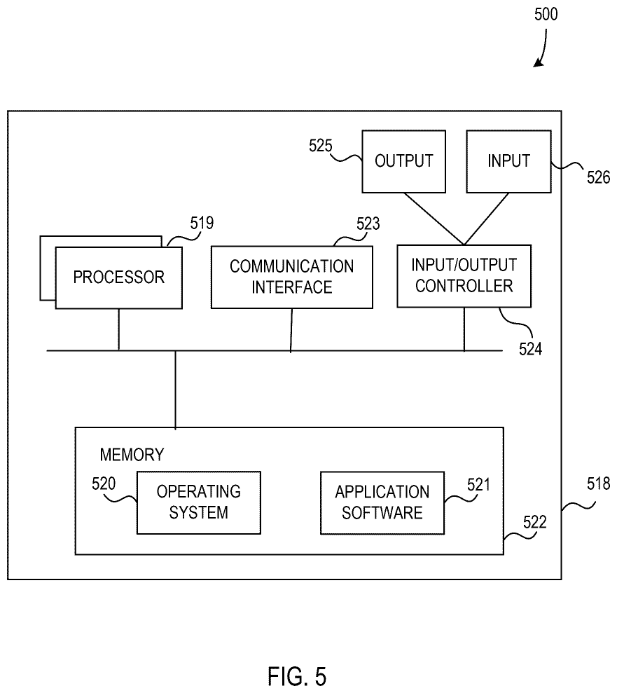

Further, in some examples, the system 100 includes one or more computing devices (e.g., the computing apparatus of FIG. 5) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the service 102 is executed on a first computing device and the regression detection platform 110 is located on a second computing device within the system 100. The first computing device and second computing device are configured to communicate with each other via network connections. Alternatively, in some examples, other components of the regression detection platform 110 (e.g., the model 114 and the regression identifier 130) are executed on separate computing devices and those separate computing devices are configured to communicate with each other via network connections during the operation of the regression detection platform 110. In other examples, other organizations of computing devices are used to implement system 100 without departing from the description.

The service 102 is configured using primarily software and/or firmware to provide a service to users and/or other software entities. In many examples, the service 102 is configured to receive input and to generate output or to otherwise perform a task based on the received input. For instance, in some examples, the service 102 includes a cloud computing service, a web service, an application programming interface (API) service, a service associated with productivity software, a data analytics service, an artificial intelligence (AI)-based service, a cyber security service, a software development service, or the like. Further, the service 102 is configured to generate error logs 104 that include information that indicates issues that arise during the operation of the service 102 (e.g., errors and/or exceptions that negatively affect the performance of the service 102). Such error logs 104 are then stored in a log data store 106.

Additionally, in some examples, the error logs 104 include information associated with errors that occur, such as indications as to where in the code of the service 102 the error occurred (e.g., a name of a software function and/or a code line indicator associated with the error). Further, in some examples, other information is included, such as the type of the error, data values or other details associated with the error, or the like.

The regression detection platform 110 is configured to obtain an error log batch 108 from the log data store 106. In some examples, the error log batch 108 includes a batch of error logs 104 from a single service 102, while in other examples, the regression detection platform 110 is configured to obtain error logs 104 from multiple services 102 such that the error log batch 108 includes error logs 104 from those multiple services 102. Additionally, or alternatively, in some examples, the regression detection platform 110 is configured to obtain the error log batch 108 periodically (e.g., once every week) and/or based on the occurrence of an event (e.g., an error associated with the service 102 is detected or a defined quantity of errors associated with the service 102 is detected). In other examples, the regression detection platform 110 obtains the error log batch 108 from the log data store 106 for other reasons without departing from the description.

Additionally, in some examples, the regression detection platform 110 is configured to process runtime stack traces (e.g., error logs 104) that are generated by software services 102 during execution and includes an Extract, Transform, Load (ETL) pipeline for extracting and processing error logs from the centralized log data store 106.

Further, in some examples, the error log batch 108 is stored in a temporary log data store 112 of the regression detection platform 110 and, from there, a model 114 (e.g., text-embedding-ada-002 or another embedding model) is used to transform the error logs 104 of the error log batch 108 into log vectors 116. In some examples, the model 114 is a machine learning (ML)/artificial intelligence (AI) model that is configured to convert or otherwise transform the data of error logs 104 into log vectors 116, or semantically encoded error traces, which are high-dimension vectors that encode the semantic meaning (e.g., the semantic encoding data 118) of the error logs 104. In some examples, the model 114 is a language model such as an LLM.

Additionally, or alternatively, the log vectors 116 generated by the model 114 are configured to include metadata 120. The metadata 120 includes indicators such as timestamp, build identifiers, operation identifiers, line numbers, or the like, such that the analysis based on a log vector 116 can be traced back to associated aspects or features of the service 102 (e.g., if a log vector 116 is found to be associated with a newly introduced anomaly, the metadata 120 of the log vector 116 is used to determine the source of the anomaly and to enable the anomaly to be directly addressed). Log vectors 116 generated by the model 114 are stored in a historical vector store 122.

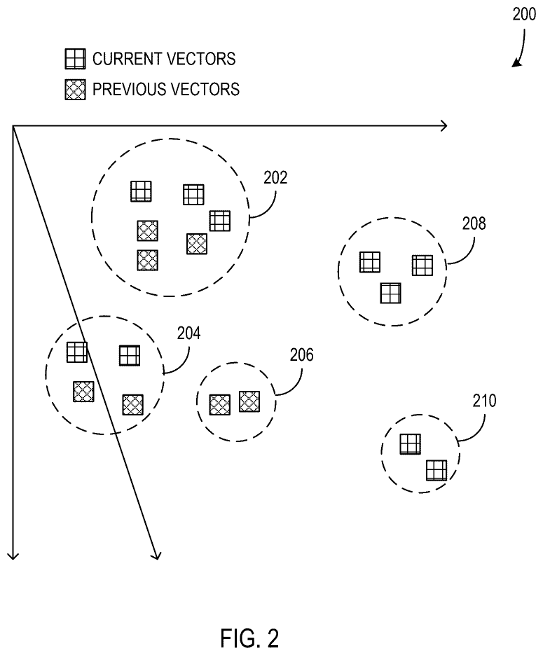

After the log vectors 116 are generated, a clustering process 126 is performed. The log vectors 116 associated with the current version or build of the service 102 and the previous log vectors 124 associated with a previous version or build of the service 102 are provided to the clustering process 126 as input. In some examples, the clustering process 126 is configured to cluster or group log vectors into log vector clusters 128 based on semantic similarity of the semantic encoding data 118 of the log vectors 116 and the previous log vectors 124. A log vector cluster 128 includes a plurality of log vectors 116 and/or previous log vectors 124 that tend to be associated with the same or similar errors or issues of the service 102. A log vector cluster 128 that includes only previous log vectors 124 represents an error that was corrected in the current version of the service 102. A log vector 128 that includes log vectors 116 and previous log vectors 124 represents an error that existed in the previous version of the service 102 and in the current version of the service 102. A log vector 128 that includes only log vectors 116 and no previous log vectors 124 represents an error or issue that is a regression (i.e., the error was not present in the previous version of the service 102 and was introduced in the current version of the service 102). Exemplary clusters are illustrated in FIG. 2.

The regression identifier 130 is configured to identify log vector clusters 128 that represent regressions (e.g., log vector clusters 128 that include only log vectors 116 of the current version of the service 102). The identified regression clusters 132 determined by the regression identifier 130 are provided to the regression mitigation module 134.

The regression mitigation model 134 is configured to perform operations to mitigate regressions in the service 102 based on the identified regression clusters 132. In some examples, metadata 120 of log vectors 116 in an identified regression cluster 132 is used to determine the function, code portion, and/or file of the service 102 to which the regression error was introduced and the determined error location is then used by the regression mitigation module 134 during the performance of mitigation operations.

In some examples, the regression mitigation module 134 is configured to generate regression alerts 136. The regression mitigation module 134 automatically generates a regression alert 136 that includes information about the associated regression error, including the determined error location within the service 102 (e.g., the file, function, line number, or other code portion). The regression alert 136 is automatically sent to a user (e.g., a “change owner” of the software) and/or another software entity that is configured to receive and process such alerts. The regression alert 136 enables a receiver of the regression alert 136 to learn about the existence of the regression error and to take action to correct or otherwise address the regression error. Additionally, or alternatively, regression alerts 136 are sent to customers to notify them of issues, possible effects thereof, and/or the predicted mitigation time associated with the issues.

Additionally, or alternatively, in some examples, the regression mitigation module 134 is configured to generate a regression report 138. The regression report 138 is generated to include information about the regression error, such as the determined error location, the rate at which the regression error occurs, the number of instances of the regression error occurring, the size of the vector cluster with which the regression error is associated, and/or other statistics associated with the regression error. Further, in some examples, the regression report 138 is generated to include comparisons to other versions of the service 102 (e.g., an immediately previous version and/or other previous versions). For instance, in an example, the regression report 138 includes a comparison of performance metrics of the current version of the service 102 and previous versions of the service 102, such that the effect of the regression error on performance of the current version of the service 102 can be observed (e.g., the various versions or builds of the service 102 are displayed in a rank or priority based on performance, accuracy, or other metrics). The regression report 138 is stored for review by a user or other software entity and/or sent to another entity for review and/or storage.

Further, in some examples, the regression mitigation module 134 is configured to perform an automated regression action 140 to correct or otherwise mitigate the regression error. In some such examples, the regression action 140 includes stopping or ending the service 102 to prevent the regression error from occurring further. Alternatively, or additionally, the regression action 140 includes reverting the service 102 to its previous version to prevent the regression error from occurring further. In some such examples, the regression mitigation module 134 is configured to analyze the frequency and effect of the regression error and, if the frequency and or effect of the regression error is determined to exceed defined thresholds, the current version of the service 102 is stopped and the previous version of the service 102 is started, such that the service 102 still operates but the regression error is prevented. In some such examples, the frequency and/or effect of the regression error is measured heuristically by measuring the size and/or other aspects of the vector cluster from which the regression error was identified (e.g., the quantity of log vectors 116 in the identified regression cluster 132, the frequency of the timestamps of those log vectors 116, or the like). In other examples, if the defined thresholds are not exceeded, the current version of the service 102 is allowed to proceed.

FIG. 2 is a diagram illustrating a 3-dimensional space 200 in which clusters 202-210 of vectors are placed. The 3D space 200 of FIG. 2 is a visual representation of the results of the clustering process 126 as described herein, but it should be understood that, in most examples, the quantity of dimensions of the log vectors is much greater than three and cannot be easily expressed in a visual way.

The 3D space 200 represents a space in which proximity indicates a degree of semantic similarity between two vectors. So, the vectors in the cluster 202 are semantically similar to each other to a sufficient degree for them to share the cluster 202. The same is true for the log vectors in all of the cluster 202-210.

The cluster 202 includes vectors from the current version of the service 102 (e.g., current vectors) and vectors from the previous version of the service 102 (e.g., previous vectors). Thus, the cluster 202 indicates the existence of an error, exception, or issue in the service 102 that was present in the previous version and that has not been addressed in the current version. Similarly, cluster 204 also includes current vectors and previous vectors. The errors or issues that are represented by clusters 202 and 204 may require mitigating action, but these errors are not considered regression errors as they were present in the previous version of the service 102.

The cluster 206 includes only previous vectors. This indicates that the error or issue represented by the cluster 206 was likely addressed by changes made in the current version of the service 102.

The clusters 208 and 210 include only current vectors. This indicates that the errors or issues represented by the clusters 208 and 210 are considered regression errors as described herein and, based on identifying the clusters 208 and 210, the regression detection platform 110 will cause mitigating regression actions to be performed.

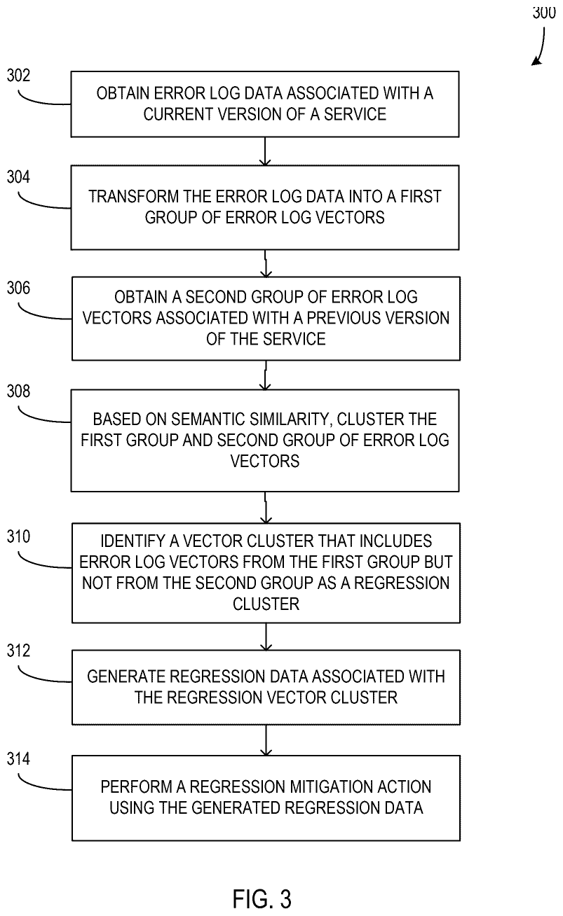

FIG. 3 is a flowchart illustrating an example method 300 for identifying and mitigating regression errors in a version of a software service. In some examples, the method 300 is executed or otherwise performed in a system such as system 100 of FIG. 1.

At 302, error log data associated with a current version or build of a software service or other program is obtained. In some examples, the error log data includes stack traces associated with errors and/or exceptions that occur during the operation of the software service. In some such examples, the stack traces include information such as operation identifiers, file identifiers, code line numbers, error timestamps, error types, or other similar stack trace data. Additionally, or alternatively, other types of error log data are obtained without departing from the description.

At 304, the error log data is transformed into a first group of error log vectors. In some examples, the error log data is transformed using a model that is configured to generate many-dimensional error log vectors that reflect the semantic meaning of the associated error log data. Further, in some examples, each error log (e.g., each stack trace) associated with an individual error is transformed into an error log vector, such that there is an error log vector generated for each error represented in the error log data.

Additionally, or alternatively, in some examples, the obtained error log data is a batch of error logs that is a defined size and/or that includes a defined quantity of error logs. In some such examples, the error logs are extracted from a data store and transformed using an ETL pipeline or the like. In examples where error log batches are used, the method 300 may be performed repeatedly to process the full set of error logs that are associated with the current version of the service and stored in the data store because there are more error logs to process than the defined batch size. Further, in some such examples, the clustering of the error log vectors as described herein may be performed after all the error log batches have been transformed into error log vectors.

At 306, a second group of error log vectors associated with a previous version of the service are obtained. In some examples, the second group of error log vectors are associated with error logs from an immediately previous version of the service (e.g., if the current version of the service is 4.4, then the second group of error log vectors are associated with version 4.3 of the service, with the understanding that other forms of version numbering can be used without departing from the description). Alternatively, or additionally, in some examples, the second group of error log vectors are associated with one or more other previous versions of the service (e.g., error logs from the previous three versions of the service).

Further, in some examples, the second group of error log vectors are obtained from a log vector data store (e.g., the historical vector store 122) and, at some point during the method 300, the first group of error log vectors are sent to the log vector data store for storage and later use in future performances of the method 300 and/or other methods described herein.

At 308, the first group of error log vectors and the second group of error log vectors are clustered based on semantic similarity. In some examples, an unsupervised clustering method or algorithm is used to group the error log vectors into groups based on semantic similarity and to identify boundaries between those various groups, resulting in a plurality of log vector clusters 128.

At 310, a vector cluster that is associated with a novel regression error is identified. In some examples, identifying the regression cluster includes determining that the vector cluster includes error log vectors from the first group but no error log vectors from the second group, such that only error log vectors associated with the most recent version of the service are present in the cluster. This indicates that the error log vectors are highly likely to be associated with a newly introduced issue in the form of a regression error.

At 312, regression data associated with the regression vector cluster is generated. In some examples, the regression data includes metadata associated with the error log vectors of the regression vector cluster (e.g., function or operation identifiers, file names, timestamps, error types or other error identifiers). Further, in some examples, the regression data includes statistics or other metrics associated with the regression vector cluster (e.g., a quantity of error log vectors, a rate at which the associated error occurs, an indicator of code responsible for the error).

At 314, a regression mitigation action is performed using the generated regression data. In some examples, the regression mitigation action includes generating a regression alert that includes at least a portion of the generated regression data. The regression alert is sent to a person and/or other software entity such that a responsible entity is informed of the regression and enabled to address the regression.

Further, in some examples, the regression mitigation action includes generating a regression report that is stored and/or sent out to defined parties. In some such examples, the regression report includes at least a portion of the regression data. Additionally, or alternatively, the regression report includes additional information, such as an ordered list of multiple versions of the service, wherein the multiple versions of the service are ordered based on one or more performance metrics, and/or an indication of a performance effect of the identified error on the current version of the service (e.g., a change in a performance metric affected by the error from the previous version of the service to the current version of the service).

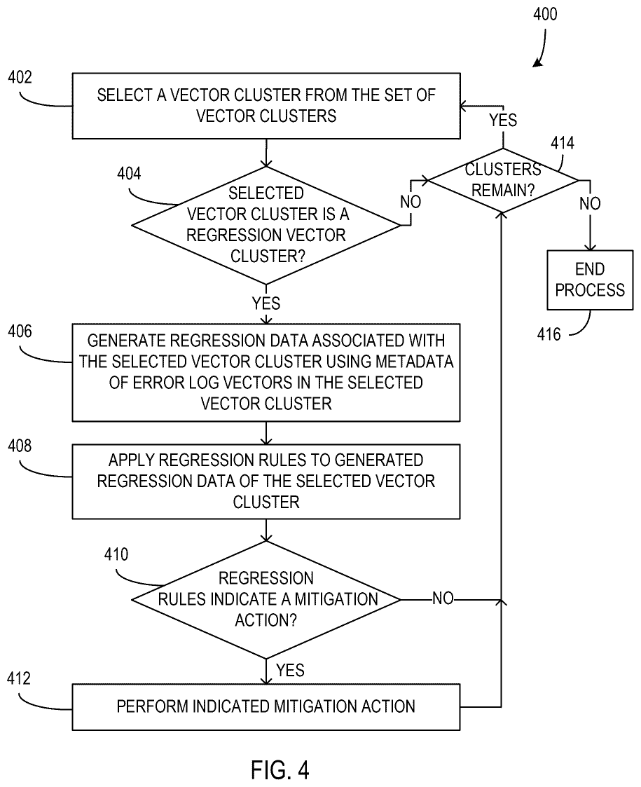

Additionally, or alternatively, in some examples, the regression mitigation action includes actions such as halting or stopping the current version of the service, preventing the current version of the service from running, suggesting a code change to address the error based on metadata of an associated error log vector, and/or causing the previous version of the service to be executed in place of the current version of the service. In some such examples, the execution of such regression mitigation actions is based on the evaluation of defined thresholds and/or other rules. This is described in greater detail below with respect to FIG. 4.

FIG. 4 is a flowchart illustrating an example method 400 for evaluating error vector clusters. In some examples, the method 400 is performed as part of other methods such as method 300 of FIG. 3. Further, in some examples, the method 400 is executed or otherwise performed by or in association with a system such as system 100 of FIG. 1.

At 402, a vector cluster is selected from a set of vector clusters. In some examples, the set of vector clusters are log vector clusters 128 that represent groups of semantically similar error log vectors. At 404, the selected vector cluster is evaluated to determine whether it is a regression vector cluster (e.g., the vector cluster is associated with one or more regression errors). If the selected vector cluster is a regression vector cluster, the process proceeds to 406. Alternatively, if the selected vector cluster is not a regression vector cluster, the process proceeds to 414. In some such examples, the selected vector cluster is a regression vector cluster if it includes only error log vectors from the most recent version of the service. In other examples, the selected vector cluster is found to be regression vector cluster if a ratio of error log vectors from the most recent version of the service to error log to total error log vectors in the cluster is sufficiently close to one (e.g., a ratio threshold of 0.99 is met or exceeded). In other examples, other aspects of the selected vector cluster are considered when determining that it is a regression vector cluster without departing from the description.

At 406, regression data associated with the selected vector cluster is generated using the metadata of the associated error log vectors as described herein. At 408, regression rules are applied to the regression data of the selected vector cluster. In some examples, the regression rules include a rule evaluating the quantity of error log vectors in the selected vector cluster, the rate at which errors associated with the error logs of the selected vector cluster occur based on timestamps, the quantity and/or types of functions affected by the associated errors, or the like. At 410, if the regression rules indicate a mitigation action should be performed, the process proceeds to 412 to perform the indicated mitigation action and then to 414. Alternatively, if the regression rules indicate that no mitigation action should be performed, the process proceeds to 414.

In some examples, each regression rule, if satisfied, may trigger a mitigation action. Alternatively, or additionally, in some examples, different types of mitigation actions are triggered based on the quantity of regression rules satisfied and/or the types of regression rules satisfied. For instance, in an example, a first error causes a large quantity of error logs to be generated but the error does not significantly affect important operations of the service, so the regression rules trigger the generation of a report and/or alert, enabling the issue to be addressed at a later date. In another example, a second error causes significant interruption or other problems with important functionality of the service, so the regression rules trigger cause the most recent version of the service to be halted and/or cause a prior version of the service to be executed in the place of the most recent version of the service.

At 414, if clusters remain to be analyzed, the process returns to 402 to select another vector cluster. Alternatively, if no clusters remain to be analyzed, the process ends at 416.

In some examples, the methods 300 and/or 400 are performed periodically for each service for which error logs are stored. Alternatively, or additionally, the methods 300 and/or 400 are triggered during the development process of services, enabling any regression errors to be identified before the service is fully deployed. Further, in some examples, the methods 300 and/or 400 may be automatically triggered based on events associated with services, such as a reduction in performance of a particular service, or the like.

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, detecting and mitigating regression errors in software services as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain a runtime stack trace data batch associated with a current version of a service from a log store; transform the runtime stack trace data batch into a first group of error log vectors, wherein the first group of error log vectors represents a semantic meaning of a stack trace of the obtained runtime stack trace data batch associated with the current version of the service; obtain a second group of error log vectors associated with a previous version of the service from a historical vector store; based on semantic similarity, cluster the first group of error log vectors and the second group of error log vectors; based on the clustering, identify a vector cluster that includes an error log vector from the first group of error log vectors and no error log vector from the second group of error log vectors as a regression vector cluster; generate regression data associated with the regression vector cluster; and perform a regression mitigation action using the generated regression data.

An example computerized method comprises obtaining error log data associated with a current version of a service from a log store; transforming the error log data into a first group of error log vectors, wherein the first group of error log vectors represents a semantic meaning of one or more error logs of the obtained error log data associated with the current version of the service; obtaining a second group of error log vectors associated with a previous version of the service from a historical vector store; based on semantic similarity, clustering the first group of error log vectors and the second group of error log vectors; based on the clustering, identifying a vector cluster that includes an error log vector from the first group of error log vectors and no error log vector from the second group of error log vectors as a regression vector cluster; generating regression data associated with the regression vector cluster; and performing a regression mitigation action using the generated regression data.

One or more computer storage media having computer-executable instructions that, upon execution by a processor, cause the processor to at least: obtain error log data associated with a current version of a service; transform the error log data into a first group of error log vectors using a trained large language model (LLM); obtain a second group of error log vectors associated with a previous version of the service; based on semantic similarity, cluster the first group of error log vectors and the second group of error log vectors; based on the clustering, identify a vector cluster that includes an error log vector from the first group of error log vectors and no error log vector from the second group of error log vectors as a regression vector cluster; and perform a regression mitigation action based on the regression vector cluster.

Alternatively, or in addition to the other examples described herein, examples include any combination of the following:
wherein the regression mitigation action includes one or more of: generating a regression report or sending a regression alert using the generated regression data, the generated regression data including a code line number at which the error occurred, a timestamp at which the error occurred, and an error type of the error.
wherein the regression mitigation action includes: generating the regression report including an ordered list of multiple versions of the service, wherein the multiple versions of the service are ordered based on a performance metric; and wherein the generated regression report includes information indicating a performance effect of a regression error associated with the regression vector cluster on the current version of the service.
wherein an error log vector from the first group of error log vectors includes semantic encoding data that represents the semantic meaning of an error log of the obtained error log data and metadata that indicates a detail of the error log, wherein the indicated detail includes one or more of: an operation identifier, a file identifier, a code line number, an error timestamp, or an error type.
wherein the regression mitigation action includes one or more of: halting the current version of the service, starting the previous version of the service, or suggesting a code change based on the metadata of the error log vector.
wherein the regression mitigation action includes: determining a size of the regression vector cluster based on a quantity of error vectors in the regression vector cluster; based on the determined size of the regression vector cluster exceeding a vector cluster size threshold, halting the current version of the service; and generating a recommendation to start the previous version of the service.
further comprising storing the first group of error log vectors in the historical vector store.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining error log data associated with a current version of a service from a log store; exemplary means for transforming the error log data into a first group of error log vectors using a model, wherein the first group of error log vectors represents semantic meaning of one or more error logs of the obtained error log data associated with the current version of the service; exemplary means for obtaining a second group of error log vectors associated with a previous version of the service from a historical vector store; based on semantic similarity, exemplary means for clustering the first group of error log vectors and the second group of error log vectors; based on the clustering, exemplary means for identifying a vector cluster that includes error log vectors from the first group of error log vectors and no error log vectors from the second group of error log vectors as a regression vector cluster; exemplary means for generating regression data associated with the regression vector cluster; and performing a regression mitigation action using the generated regression data.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
obtain a runtime stack trace data batch associated with a current version of a service from a log store;
transform the runtime stack trace data batch into a first group of error log vectors, wherein the first group of error log vectors represents a semantic meaning of a stack trace of the obtained runtime stack trace data batch associated with the current version of the service;
obtain a second group of error log vectors associated with a previous version of the service from a historical vector store;
based on semantic similarity, cluster the first group of error log vectors and the second group of error log vectors;
based on the clustering, identify a vector cluster that includes an error log vector from the first group of error log vectors and no error log vector from the second group of error log vectors as a regression vector cluster;
generate regression data associated with the regression vector cluster; and
perform a regression mitigation action using the generated regression data.

2. The system of claim 1, wherein the regression mitigation action includes one or more of: generating a regression report or sending a regression alert using the generated regression data, the generated regression data including a code line number at which an error occurred, a timestamp at which the error occurred, and an error type of the error.

3. The system of claim 2, wherein the regression mitigation action includes:
generating the regression report including an ordered list of multiple versions of the service, wherein the multiple versions of the service are ordered based on a performance metric; and
wherein the generated regression report includes information indicating a performance effect of a regression error associated with the regression vector cluster on the current version of the service.

4. The system of claim 1, wherein an error log vector from the first group of error log vectors includes semantic encoding data that represents the semantic meaning of a stack trace of the obtained runtime stack trace data batch, and the error log vector includes metadata that indicates a detail of the stack trace, wherein the indicated detail include one or more of: an operation identifier, a file identifier, a code line number, an error timestamp, or an error type.

5. The system of claim 4, wherein the regression mitigation action includes one or more of:
halting the current version of the service, starting the previous version of the service, or suggesting a code change based on the metadata of the error log vector.

6. The system of claim 1, wherein the regression mitigation action includes:
determining a size of the regression vector cluster based on a quantity of error vectors in the regression vector cluster;
based on the determined size of the regression vector cluster exceeding a vector cluster size threshold, halting the current version of the service; and
generating a recommendation to start the previous version of the service.

7. The system of claim 1, wherein the memory and the computer program code are configured to further cause the processor to store the first group of error log vectors in the historical vector store.

8. A computerized method comprising:
obtaining error log data associated with a current version of a service from a log store;
transforming the error log data into a first group of error log vectors, wherein the first group of error log vectors represents a semantic meaning of one or more error logs of the obtained error log data associated with the current version of the service;
obtaining a second group of error log vectors associated with a previous version of the service from a historical vector store;
based on semantic similarity, clustering the first group of error log vectors and the second group of error log vectors;
based on the clustering, identifying a vector cluster that includes an error log vector from the first group of error log vectors and no error log vector from the second group of error log vectors as a regression vector cluster;
generating regression data associated with the regression vector cluster; and
performing a regression mitigation action using the generated regression data.

9. The computerized method of claim 8, wherein the regression mitigation action includes one or more of: generating a regression report or sending a regression alert using the generated regression data, the generated regression data including a code line number at which the error occurred, a timestamp at which the error occurred, and an error type of the error.

10. The computerized method of claim 9, wherein the regression mitigation action includes:
generating the regression report including an ordered list of multiple versions of the service, wherein the multiple versions of the service are ordered based on a performance metric; and
wherein the generated regression report includes information indicating a performance effect of a regression error associated with the regression vector cluster on the current version of the service.

11. The computerized method of claim 8, wherein an error log vector from the first group of error log vectors includes semantic encoding data that represents the semantic meaning of an error log of the obtained error log data and metadata that indicates a detail of the error log, wherein the indicated detail includes one or more of: an operation identifier, a file identifier, a code line number, an error timestamp, or an error type.

12. The computerized method of claim 11, wherein the regression mitigation action includes one or more of: halting the current version of the service, starting the previous version of the service, or suggesting a code change based on the metadata of the error log vector.

13. The computerized method of claim 8, wherein the regression mitigation action includes:
determining a size of the regression vector cluster based on a quantity of error vectors in the regression vector cluster;
based on the determined size of the regression vector cluster exceeding a vector cluster size threshold, halting the current version of the service; and
generating a recommendation to start the previous version of the service.

14. The computerized method of claim 8, further comprising storing the first group of error log vectors in the historical vector store.

15. A computer storage medium has computer-executable instructions that, upon execution by a processor, cause the processor to at least:
obtain error log data associated with a current version of a service;
transform the error log data into a first group of error log vectors using a trained large language model (LLM);
obtain a second group of error log vectors associated with a previous version of the service;
based on semantic similarity, cluster the first group of error log vectors and the second group of error log vectors;
based on the clustering, identify a vector cluster that includes an error log vector from the first group of error log vectors and no error log vector from the second group of error log vectors as a regression vector cluster; and
perform a regression mitigation action based on the regression vector cluster.

16. The computer storage medium of claim 15, wherein the regression mitigation action includes one or more of: generating a regression report or sending a regression alert including a code line number at which an error occurred, a timestamp at which the error occurred, and an error type of the error.

17. The computer storage medium of claim 16, wherein the regression mitigation action includes:
generating the regression report including an ordered list of multiple versions of the service, wherein the multiple versions of the service are ordered based on a performance metric; and
wherein the generated regression report includes information indicating a performance effect of a regression error associated with the regression vector cluster on the current version of the service.

18. The computer storage medium of claim 15, wherein an error log vector of the first group of error log vectors includes semantic encoding data that represents semantic meaning of an error log of the obtained error log data and metadata that indicates a detail of the error log, wherein the indicated detail includes at least one of an operation identifier, a file identifier, a code line number, an error timestamp, or an error type.

19. The computer storage medium of claim 18, wherein the regression mitigation action includes one or more of: halting the current version of the service, starting the previous version of the service, or suggesting a code change based on the metadata of the error log vector.

20. The computer storage medium of claim 15, wherein the regression mitigation action further includes:
determining a size of the regression vector cluster based on a quantity of error vectors in the regression vector cluster;
based on the determined size of the regression vector cluster exceeding a vector cluster size threshold, halting the current version of the service; and
generating a recommendation to start the previous version of the service.
